(19) United States
(12) Patent Application Publication
(10) Pub. No.: US 2009/0211522 A1
(43) Pub. Date: Aug. 27, 2009

(54) Use of Variable Frequency Microwaves to Control the Teflon Profile of Gas Diffusion Media

(75) Inventors: Stephen Perl, Strykersville, NY (US); Anastasios Angelopoulos, Cincinnati, OH (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/035,307

(22) Filed: Feb. 21, 2008

(51) Int. Cl. B05C 3/02; H05B 6/64

(52) U.S. Cl. 118/642; 427/595

(57) ABSTRACT

A method for fabricating diffusion media for a fuel cell that includes using variable frequency microwaves for heating the diffusion media after it has been coated with a solvent including fluorocarbon particles to provide broader control over the distribution of the fluorocarbon on the diffusion media. In one embodiment, a carbon fiber substrate is dipped in a solution including the fluorocarbon particles and a surfactant. The wet and coated substrate is then dried using the microwave radiation, where the frequency of the microwave radiation is varied to increase or control the dispersion of the fluorocarbon particles and the hydrophobicity of the diffusion media. In one embodiment, the microwave radiation is varied in frequency between 500 MHz and 1000 GHZ.

### BACKGROUND OF THE INVENTION

1. Field of the Invention

This invention relates generally to diffusion media for a fuel cell and, more particularly, to diffusion media for a fuel cell, where a variable frequency microwave heating process is used to dry a solvent including fluorocarbon particles on the diffusion media during media fabrication to provide a broader control of the distribution of the fluorocarbon particles on the diffusion media and increase the hydrophobicity of the diffusion media.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. The PEMFC generally includes a solid polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Several fuel cells are typically combined in a fuel cell stack to generate the desired power. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The fuel cell stack includes a series of flow field or bipolar plates positioned between the several MEAs in the stack. The bipolar plates include an anode side and a cathode side for adjacent fuel cells in the stack Anode gas flow channels are provided on the anode side of the bipolar plates that allow the anode gas to flow to the anode side of each MEA. Cathode gas flow channels are provided on the cathode side of the bipolar plates that allow the cathode gas to flow to the cathode side of each MEA. The bipolar plates are made of a conductive material, such as stainless steel, so that they conduct the electricity generated by the fuel cells from one cell to the next cell as well as out of the stack. The bipolar plates also include flow channels through which a cooling fluid flows.

FIG. 1 is a cross-sectional view of a fuel cell 10 of the type discussed above. The fuel cell 10 includes a cathode side 12 and an anode side 14 separated by an electrolyte membrane 16. A cathode side diffusion media layer 20 is provided on the cathode side 12, and a cathode side catalyst layer 22 is provided between the membrane 16 and the diffusion media layer 20. Likewise, an anode side diffusion media layer 24 is provided on the anode side 14, and an anode side catalyst layer 26 is provided between the membrane 16 and the diffusion media layer 24. The catalyst layers 22 and 26 and the membrane 16 define an MEA. The diffusion media layers 20 and 24 are porous layers that provide for input gas transport to and water transport from the MEA. Various techniques are known in the art for depositing the catalyst layers 22 and 26 on the diffusion media layers 20 and 24, respectively, or on the membrane 16.

A cathode side flow field plate or bipolar plate 18 is provided on the cathode side 12 and an anode side flow field plate or bipolar plate 30 is provided on the anode side 14. The bipolar plates 18 and 30 are positioned between the fuel cells in a fuel cell stack. A hydrogen gas flow from flow channels 28 in the bipolar plate 30 reacts with the catalyst layer 26 to dissociate the hydrogen ions and the electrons. Airflow from flow channels 36 in the bipolar plate 18 reacts with the catalyst layer 22. The hydrogen ions are able to propagate through the membrane 16 where they electro-chemically react with the airflow and the return electrons in the catalyst layer 22 to generate water as a by-product.

As is well understood in the art, the membrane 16 needs to have a certain relative humidity so that the ionic resistance across the membrane 16 is low enough to effectively conduct protons. During operation of the fuel cell 10, the water by-product, liquid water and/or water vapor, from the MEAs and external humidification may enter the anode and cathode flow channels 28 and 36. The water may accumulate in the flow channels 28 and 36, especially at low loads where the flow rate of the reactant gas will be low. It has been shown that water accumulation becomes a problem at cell current densities below 0.2-0.4 A/cm² and cell stoichiometry between 2 and 4.

The gas diffusion media layers 20 and 24 provide reactant and product permeability, electrical conductivity, heat conductivity and mechanical strength for proper fuel cell operation. One important function of the diffusion media layers 20 and 24 is to provide water management. Particularly, the diffusion media layers 20 and 24 prevent cell flooding by wicking product water away from the catalyst layers 22 and 26 while maintaining reactant gas flow from the bipolar plates 18 and 30 to the catalyst layers 22 and 26.

The gas diffusion media layers 20 and 24 are typically made of carbon fiber containing materials. Although carbon fibers are relatively hydrophobic, it is typically desirable to increase the hydrophobicity of the diffusion media layers 20 and 24, usually by treating the carbon fibers with a fluorocarbon coating to get a more stable hydrophobicity. An example of a suitable hydrophobic agent is polytetrylflorylethlene (PTFE) that increases and/or stabilizes the hydrophobicity of the diffusion media layers 20 and 24. Know techniques for adding the PTFE to carbon fiber substrate include dipping carbon fiber paper into a solution that contains PTFE particles and surfactants and rolling the material on the substrate.

Even though coating the diffusion media layers 20 and 24 with PTFE particles improves cell performance, known processes for preparing the coated diffusion media layers 20 and 24 have typically provided inconsistent results.

### SUMMARY OF THE INVENTION

In accordance with the teachings of the present invention, a method for fabricating diffusion media for a fuel cell is disclosed that includes using variable frequency microwaves for drying the diffusion media after it has been coated with a solvent including fluorocarbon particles to provide broader control over the distribution of the fluorocarbon on the diffusion media. In one embodiment, a carbon fiber substrate is dipped in a solution including the fluorocarbon particles and a surfactant. The wet and coated substrate is then dried using the microwave radiation, where the frequency of the microwave radiation is varied to increase or control the dispersion of the fluorocarbon particles and the hydrophobicity of the diffusion media. In one embodiment, the microwave radiation is varied in frequency between 500 MHz and 1000 GHZ.

Additional advantages and features of the present invention will become apparent from the following description and appended claims, taken in conjunction with the accompanying drawings.

### BRIEF DESCRIPTION OF THE DRAWINGS

FIG. 1 is a cross-sectional view of a fuel cell in a fuel cell stack; and

FIG. 2 is a plan view of a process for dipping a diffusion media substrate in an aqueous solution including fluorocarbon particles and then drying the substrate using variable frequency microwave radiation, according to an embodiment of the present invention.

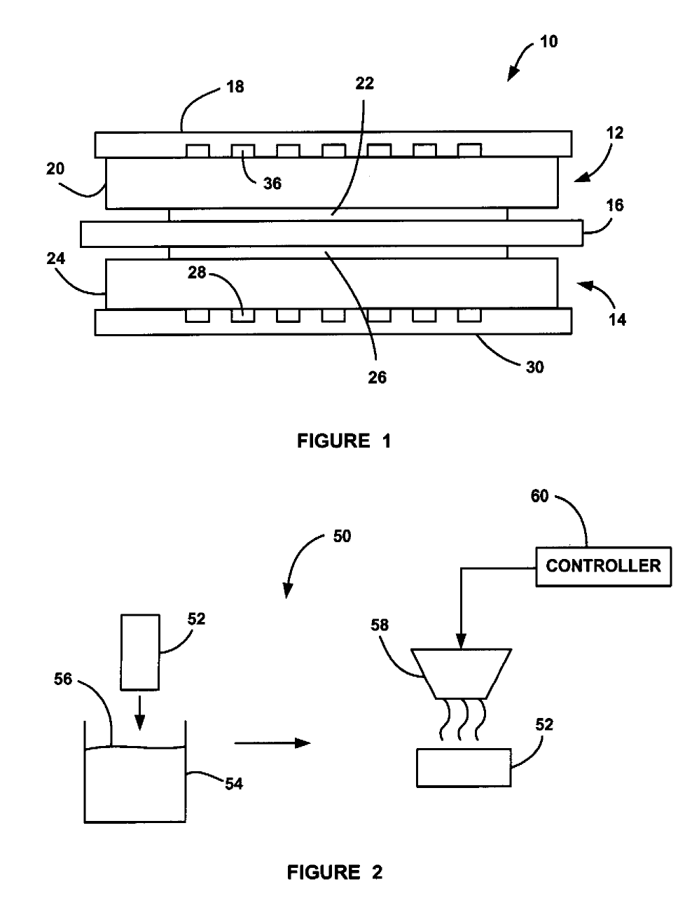

### DETAILED DESCRIPTION OF THE EMBODIMENTS

The following discussion of the embodiments of the invention directed to a technique or fabricating diffusion media for a fuel cell is merely exemplary in nature, and is in no way intended to limit the invention or its applications or uses.

U.S. application Ser. No. 10/924317, titled Control of Polymer Surface Distribution on Diffusion Media for Improved Fuel Cell Performance, filed Aug. 23, 2004, assigned to the Assignee of this application and herein incorporated by reference, discloses a technique for fabricating diffusion media for a fuel cell. The '317 application describes a diffusion media for a fuel cell that includes a carbon to fluorine (C/F) ratio between 8 and 20, as measured by energy dispersive spectroscopy on the surface of the diffusion media that is exposed to the flow field. A low C/F ratio indicates the surface of the diffusion media contains a high amount of fluorine and a high C/F ratio indicates a low coverage of fluorine on the diffusion media. Using a diffusion media having a consistent fluorine distribution leads to fuel cells that exhibit a relative constant voltage over a wide range of reactant gas flow rates.

The diffusion media is fabricated by preparing fluorine coated carbon fiber substrates, including applying a polymer composition comprising a fluorocarbon polymer in a solvent, for example water, to at least one surface of the carbon fiber based substrate. The aqueous dispersion may contain an organic solvent. In one embodiment, the fluorocarbon is polytetrofluoroethylene (PTFE). The solvent is removed from the substrate to leave a film of the fluorocarbon deposited on the substrate. The rate of removal of the solvent is generally slower than would be achieved by heating the coated substrate at, near or above the boiling paint of the solvent. In other embodiments, the solvent is removed by heating the substrate below the boiling point of the solvent, for example, in a quiescent convection oven. In another embodiment, the temperature of the heat used to dry the solvent is 20°-30° below the boiling point of the solvent.

In one embodiment, the solvent is removed by exposing the substrate to electromagnetic radiation having a wavelength above that of visible light, and at an intensity and for a time sufficient to remove the solvent from the carbon fiber based substrate. Suitable electromagnetic radiation used to remove the solvent includes infrared radiation, far infrared radiation, microwave radiation and a radio frequency.

As discussed above, the '317 process fabricates carbon fiber diffusion media by dipping a substrate, such as a carbon fiber paper or carbon fiber fabric, into a solution containing fluorocarbons particles, such as PTFE particles. During this process, particles of fluorine containing polymer are imbibed within the porous carbon fiber paper, and the solution covers both the binder regions and the carbon fibers. It is believed that when the solvent is rapidly removed by heating the substrate at a temperature above the boiling point of the solvent, at least a portion of the fluorocarbon particles form a large deposit of the particles on the binder. These relatively thick deposits of the fluorocarbon particles are formed during the solvent drying process, and remain in the same position during the high temperature fluorocarbon centering process that follows the drying process.

In one embodiment, the carbon fiber substrate is a carbon fiber based paper made by a process beginning with a continuous filament fiber of a suitable organic polymer. After a stabilization period, the continuous filament is carbonized at a temperature of about 1200°-1350° C. and chopped to provide shorter staple carbon fibers. Thereafter, the staple fibers are impregnated with an organic resin and molded into sheets. The molded sheets may then be carbonized or graphitized at temperatures above 2000° C. to form the carbon fiber paper. The substrates may take the form of carbon fiber paper, wet laid filled paper, carbon cloth or dry laid filled paper.

The carbon fibers are impregnated in the substrate with a carbonizable thermal set resin. Generally, any thermal set resin may be used. Phenolic resins are usually preferred because of their high carbon yield and relatively low cost. After a final carbonization or graphitization, the carbon fiber paper has a structure characterized as carbon fibers held together with a binder, where the binder is made up of the carbonized thermal set resin.

A fluorocarbon coating is applied to the carbon fiber substrate by applying a polymer composition to at least one surface of the substrate. The polymer solution contains a fluorocarbon polymer, a solvent and a surfactant. PTFE provides one good fluorocarbon polymer, but other fluorine containing polymers may also be used, such as copolymers of hexafluoropropylene and tetrafluoroethylene (FEP), copolymers of tetrafluoroethylene and perfluoropropylvinylether (PFA), copolymers of tetrafluoroethylene and perfluoromethovinylether (MFA), homopolymers of chlorotrifluoroethylene (PCTFE), homopolymers of vinylidenefluoride (PVDF), polymers of vinylfluoride (PVF), copolymers of ethylene and tetrafluoroethylene (ETFE), and copolymers of vinylidenefluoride, hexafluoropropylene and tetrafluoroethylene (THV).

Additionally, a wide variety of surfactants may be used as long as they can maintain the fluorocarbon polymer particles in a stable dispersion and permit penetration of the solution to the pores of the diffusion media. Non-limiting examples of surfactant include nonylphenol ethoxylates, such as Triton series of Rhom and Haas, and perfluorosurfactants.

A wide range of loading of PTFE or other fluorocarbons may be applied to the carbon fiber substrate. In certain embodiments, it is desirable to incorporate about 2-30% fluorine by weight of the diffusion media, where the percent of fluorine is measured after the drying. In other embodiments, at least 5% by weight of fluorine is incorporated into the diffusion media. Typically, the substrate may be dipped or immersed in the fluorocarbon dispersion for a few minutes up to a few hours to obtain an appropriate loading of fluorocarbon on the substrate. Also, the dispersion into which the substrate is dipped or immersed may contain 1% to 50% by weight of fluorocarbon particles. Dispersions having concentrations of particles in the preferred range may be made by diluting commercial sources of the dispersions as necessary to achieve the desired concentration. In one example, a dispersion containing 60% by weight of fluorocarbon may be diluted 20 times with deionized water to produce a dispersion containing 3% by weight of fluorocarbon particles.

The time of exposing the substrate to the fluorocarbon polymer dispersion is long enough for the resin particles to imbibe into the pores of the carbon fiber or cloth, but short enough to be an economically viable process. Similarly, exposure of the dispersion to the substrate at room temperature is desirable. Higher temperatures may be used, but in some embodiments this is less preferred because of expense. Generally, the time of soaking and the concentration of the fluorocarbon particles, as well as the nature of the resin, may be varied and optimized to achieve desired results.

When the diffusion media is dried to remove the solvent, the solvent can be removed at a rate less than what would be achieved by heating the substrate above the boiling point of the solvent.

In one embodiment, the substrate drying process discussed above uses microwave radiation at a frequency in the range from about 500 MHz to about 1000 GHz to provide the heating for substrate drying. The resultant cross-sectional fluorocarbon particle profile on the substrate from a single frequency heating may be parabolic in nature, and thus may not have a consistent deposition of the fluorocarbon particles on the diffusion media. The present invention proposes using variable frequency microwave heating during the substrate drying process to achieve an even broader control of the distribution of the fluorocarbons particles both on the surface and through the bulk of the diffusion media layers. This improves gas diffusion media water removal properties and fuel cell performance.

Variable frequency microwave heating can provide selective heating of targeted areas on both the gas diffusion media substrate as well as the suspension containing the fluorocarbon particles to be deposited onto and into the gas diffusion media. Previous studies have shown that the agglomeration and deposition of the fluorocarbon particles is controlled by the drying rate of the suspension. The level of control of the fluorocarbon particle distribution achievable through variable frequency microwave heating can not be achieved by any other technique.

FIG. 2 shows a process 50 for preparing a diffusion media substrate 52, where in one embodiment the substrate 52 is a piece of carbon fiber paper or carbon fiber fabric. The substrate 52 is first dipped in a container 54 including an aqueous solution 56 including a fluorine surfactant and fluorocarbon particles, such as PTFE particles. The substrate dipping process and the solution 56 can be any of those discussed above. The wet substrate 52 is then dried using a microwave source 58 so that the fluorocarbon particles are suitably dispersed on the substrate 52 when it is dried. The fluorocarbon particles increase the hydrophobicity of the diffusion media, which will then increase the fuel cell performance. According to the invention, a frequency controller 60 varies the frequency of the microwave radiation during the drying process so as to increase the control of the fluorocarbon particle dispersion. In one embodiment, the frequency is varied between 500 MHz and 1000 GHz. The controller 60 can ramp the frequency from the lowest frequency to the highest frequency, or can vary the frequency in other ways.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for fabricating diffusion media for a fuel cell, said method comprising:
providing a diffusion media substrate;
applying a solvent including a fluorocarbon to the substrate; and
heating the substrate using electromagnetic radiation to dry the solvent so that the fluorocarbon is dispersed on the substrate, wherein heating the substrate includes varying the frequency of the electromagnetic radiation.

2. The method according to claim 1 wherein heating the substrate using electromagnetic radiation includes using microwave radiation.

3. The method according to claim 2 wherein varying the frequency of the electromagnetic radiation includes varying the frequency of the microwave radiation in the range from about 500 MHz to about 1000 GHz.

4. The method according to claim 1 wherein applying a solvent to the substrate includes applying a solvent including PTFE particles.

5. The method according to claim 1 wherein applying a solvent to the substrate includes dipping the substrate in an aqueous solution.

6. The method according to claim 1 wherein providing a substrate includes providing a carbon fiber substrate.

7. The method according to claim 1 wherein the dried diffusion media substrate has a carbon to fluorine (C/F) ratio between 8 and 20.

8. The method according to claim 1 wherein the fuel cell is part of a fuel cell stack on a vehicle.

9. A system for fabricating diffusion media for a fuel cell, said system comprising:
a device for applying a solvent including a fluorocarbon to a diffusion media substrate; and
a heating apparatus for drying the solvent on the substrate, wherein the heating apparatus uses electromagnetic radiation to dry the substrate, said heating apparatus varying the frequency of the electromagnetic radiation.

10. The system according to claim 9 wherein the electromagnetic radiation is microwave radiation.

11. The system according to claim 10 wherein the heating apparatus varies the frequency of the microwave radiation in the range from about 500 MHz to about 1000 GHz.

12. The system according to claim 9 wherein the solvent includes PTFE particles.

13. The system according to claim 9 wherein the substrate is a carbon fiber substrate.

14. The system according to claim 9 wherein the device includes a container holding an aqueous solution.

15. The system according to claim 9 wherein the dried diffusion media substrate has a carbon to fluorine (C/F) ratio between 8 and 20.

16. The system according to claim 9 wherein the fuel cell is part of a fuel cell stack on a vehicle.

17. A system for fabricating diffusion media for a fuel cell, said system comprising:
a device for applying a solvent including PTFE particles to a carbon fiber substrate; and
a heating apparatus for drying the solvent on the substrate, wherein the heating apparatus uses microwave radiation to dry the substrate, said heating apparatus varying the frequency of the microwave radiation within a frequency range of about 500 MHz to about 1000 GHz, wherein the dried diffusion media substrate has a carbon to fluorine (C/F) ratio between 8 and 20.

18. The system according to claim 17 wherein the device includes a container holding an aqueous solution.

19. The system according to claim 17 wherein the fuel cell is part of a fuel cell stack on a vehicle.
